(19) United States
(12) Patent Application Publication
(10) Pub. No.: US 2026/0275955 A1
(43) Pub. Date: Sep. 17, 2026

(54) METHOD AND SYSTEM FOR CONVERTING MECHANICAL ENERGY OF AN OSCILLATING BODY INTO ELECTRICAL ENERGY

(71) Applicant: Universidad del País Vasco /Euskal Herriko Unibertsitatea, Vizcaya (ES)

(72) Inventors: Ainhoa Etxebarria Egizabal, Vizcaya (ES); Rafael Bárcena Ruiz, Vizcaya (ES)

(21) Appl. No.: 19/471,540

(22) PCT Filed: Apr. 5, 2024
(86) PCT No.: PCT/EP2024/059352

§ 371 Date: Oct. 1, 2025

(30) Foreign Application Priority Data
Apr. 5, 2023 (ES) P202330285

(51) Int. Cl. F03B 13/14; F03B 13/20; F03B 15/00

(52) U.S. Cl. CPC F03B 13/145; F03B 13/20; F03B 15/00; F05B 2270/20

(57) ABSTRACT

A method for converting mechanical energy from oscillations into electrical energy, the method including adjusting a displacement of a mass mechanically coupled to an electrical machine, the coupling being such that the electrical machine generates the electrical energy from the displacement of the mass in the oscillations, the displacement being with respect to an oscillating body; the displacement being adjusted by means of an adjustment of a force applied by the electrical machine to the mass; and the applied force being adjusted by means of a controller configured so that a control objective is to achieve that an instantaneous velocity of the displacement of the mass is positively accelerated by a gravitational force applied to the mass at certain instants of the oscillations.

### TECHNICAL FIELD

The present invention relates in general to a method for converting mechanical energy from the oscillations of an oscillating body into electrical energy. It also refers to systems suitable for such conversion. Specifically, to such methods and systems in which a dynamic control is applied.

### BACKGROUND

Systems for generating electrical energy from the oscillatory movements of a body are already known in the prior art. For example, systems for generating electrical energy from wave energy are known. Some of these systems are equipped with one or more movable masses placed on a floating body, a movement of the masses being caused by an oscillatory movement of the floating body induced by the waves. These systems comprise a mechanical conversion system (e.g., a hydraulic conversion system) for converting kinetic energy of the movable masses into electrical energy.

In an example disclosed in WO2012/046053A2, an apparatus installable on a vessel comprises movable masses and generates energy from impacts of movable masses against pressure-controlling pistons of a fluid. Thus, when the vessel tilts, the movable masses move until they collide with the respective pistons, causing a displacement of the respective pistons. This displacement of the pistons causes an increase in fluid pressure, causing a movement of a turbine of an electric power generator.

However, this form of electric power generation has a relatively low energy conversion efficiency (e.g., because some of the energy is dissipated in the collision and due to potential irreversibilities of the fluid compression), and the movement of the movable masses has a relatively high destabilization risk of the vessel, as the center of gravity of the vessel is modified due to the displacement of the masses.

WO2017/137561A1 discloses a device for converting wave energy into electrical energy, the device being placed on a floating apparatus, for example, a boat or a buoy. The device comprises a sliding mass and a guide of the sliding of the mass. The mass is mechanically connected to a rotor of an electric generator in such a way that the displacement of the mass causes the turning of the rotor and consequently the generation of electrical energy by the electric generator. Thus, the device converts kinetic energy of the rotor into electrical energy along the displacement of the mass, instead of only at the collision of a movable mass as mentioned above, and thus increases the conversion efficiency of mechanical energy into electrical energy. Furthermore, WO2017/137561A1 comprises a mechanical coupling that prevents the rotor from stopping when the direction of displacement of the movable mass changes. Thus, the generation of electrical energy at low rotor velocities is avoided, i.e., low voltage and current electrical energy that has little practical usefulness, and abrupt rotor velocity variations caused by braking to zero rotor velocity and subsequent rotor acceleration are minimized. Furthermore, in order to increase the kinetic energy of the mass, the device comprises elastic elements at the ends of the guide that allow making use of part of the braking and acceleration energy of the mass when changing the direction of displacement of the mass.

Finally, WO2019/245530A1 proposes a system for the extraction of energy from ocean waves that includes the concept of managing the dynamics of movable masses installed aboard a floating body. Such management is proposed by defining, during each oscillation, a mass acceleration phase, and a deceleration phase. In the first phase, gravity acts on the mass, which moves freely, disconnected from an inertia flywheel coupled, in turn, to an electric generator. In the second phase, coupling and subsequent regenerative braking of the mass occurs. The duration of both phases can be altered by manipulating the longitude of extensible clamping lines, in order to minimize the loss of kinetic energy produced when the mass collides with the elastic stops arranged at both ends of the stroke of the mass. This alteration must be made based on the wave height at each instant and even mentions the use of an automatic controller for this purpose. However, no way to achieve this objective is described.

From the above, it can be extracted that it is desirable a conversion of the mechanical energy of oscillations of an oscillating body that makes it possible to obtain a higher conversion efficiency of mechanical energy into electrical energy through the use of one or more movable masses, while managing the velocity and position of such mass(es), depending on the oscillation undergone by the structure where it (they) is (are) installed.

### DESCRIPTION OF THE INVENTION

Normally, in the systems already known in the prior art to generate electrical energy from oscillatory movements of a body, the use of an electrical machine (used as a generator) is required, but the management of the torque (also known as moment of force) of the electrical machine, more specifically the electromagnetic torque (also known as electromagnetic moment of force) of the electrical machine, is not harnessed to implement a dynamic control of the mass. However, such control can be very useful to generate as much electrical power as possible, while also controlling the stability of the oscillating body as a whole and the confined stroke of the mass. This invention is based on implementing the dynamic control of the mass using the torque of the electrical machine mechanically coupled to the mass. This dynamic control makes it possible to adapt the movement of the mass at each instant to the movement of the oscillating body. Logically, the movement of the oscillating body, in the case in which the oscillating body is a body floating in water, depends, among other factors, on the wave incident on the body.

Thus, while other methods use an electric generator that applies a constant electrical torque and confine the mass movement (while extracting energy from the mass movement), by mechanical and/or hydraulic methods (e.g., using stops, springs, inertia flywheels, clamping lines, . . . ), the present invention adjusts the instantaneous electromagnetic torque of the electrical machine to optimize the displacement of the mass. To ensure that the position of the mass is the most suitable at every instant, the electrical machine can operate in the four quadrants, primarily functioning as electric power generator, but, at certain times, as an electric motor.

To overcome the drawbacks of the prior art, a first aspect of the present invention relates to a method for converting mechanical energy from oscillations of an oscillating body into electrical energy, the method comprising adjusting a displacement of a mass mechanically coupled to a electrical machine, the coupling being such that the electrical machine generates the electrical energy from the displacement of the mass in the oscillations, the displacement being with respect to the oscillating body; the mass being mechanically coupled to the body, the mechanical coupling of the mass to the body allowing the displacement of the mass caused by a gravitational force and by a force of the electrical machine applied to the mass in the oscillations; the oscillations causing variations of an angle of inclination of the oscillating body with respect to the direction of the gravitational force; the displacement being adjusted by means of an adjustment of the force applied by the electrical machine to the mass; the force applied by the electrical machine being adjusted by means of a controller on the basis of a measurement of an instantaneous angle of inclination of the oscillating body and on the basis of at least one of: a measurement of an instantaneous position of the mass with respect to the oscillating body and a measurement of an instantaneous velocity of the displacement of the mass; and the controller being configured so that a control objective of the adjustment of the force applied by the electrical machine is to achieve that an instantaneous velocity of the displacement of the mass is positively accelerated by the gravitational force applied to the mass at all instants of the oscillations in which:
the subtraction of the instantaneous angle of inclination of the oscillating body minus the angle of inclination of the body at rest has opposite sign to the sign of the angle of inclination of the body at rest, and the absolute value of the subtraction of the instantaneous angle of inclination of the oscillating body minus the angle of inclination of the body at rest is greater than the absolute value of the angle of inclination of the body at rest; and/or
the subtraction of the instantaneous angle of inclination of the oscillating body minus the angle of inclination of the body at rest has the same sign than the angle of inclination of the body at rest;

the instantaneous angle of inclination being an angle with respect to a plane perpendicular to the direction of the gravitational force, and the angle of inclination of the body at rest being an angle with respect to the plane perpendicular to the direction of the gravitational force.

The method uses a mass that moves (due to, for example, waves) within an oscillating body (e.g., a floating body), through, for example, guides of the displacement of the mass that limit degrees of freedom of the mass movement with respect to the body. At least one electrical machine is mechanically coupled to the mass. The electrical machine makes it possible to control the movement of the mass in those degrees of freedom (e.g., in a single degree of freedom) by positively accelerating the mass (i.e., as an electric motor) or braking the mass (i.e., as an electric power generator) at each instant, as appropriate, by adjusting the electromagnetic torque of the electrical machine. To adjust the torque, a control algorithm is used with the aim of ensuring that the instantaneous velocity of the displacement of the mass is positively accelerated by the gravitational force applied to the mass:
at all instants of the oscillations in which the subtraction of the instantaneous angle of inclination of the oscillating body minus the angle of inclination of the body at rest has opposite sign to the sign of the angle of inclination of the body at rest, and the absolute value of the subtraction of the instantaneous angle of inclination of the oscillating body minus the angle of inclination of the body at rest is greater than the absolute value of the angle of inclination of the body at rest (in other words, if sign(φ−φ₀)≠sign(φ₀) and |φ−φ₀|>|φ₀|, where φ is the instantaneous angle of inclination of the oscillating body and φ₀ is the angle of inclination of the body at rest); and/or (preferably “and” instead of “or” to allow maximizing the electrical energy generation)
at all instants of the oscillations in which the subtraction of the instantaneous angle of inclination of the oscillating body minus the angle of inclination of the body at rest has the same sign than the angle of inclination of the body at rest (in other words, sign(φ−φ₀)=sign(φ₀)).

The control objective makes it possible to maximize the electrical power generated. Furthermore, it has been observed that this way of maximizing the electrical power generated allows, as an additional and secondary effect, to improve the stability of the oscillating body and to keep the movement of the mass confined to a predetermined range. By extracting electrical energy from the movement of the oscillating body due to, for example, waves, said oscillating motion attenuates more the more mechanical energy is converted into electrical energy.

In order to maximize the electrical energy generated, it is desirable that, at the instants of the oscillations mentioned above, the instantaneous velocity of the displacement of the mass is positively accelerated by the gravitational force applied to the mass. The control objective makes it possible to minimize the braking that the gravitational force applied to the mass exerts on the mass, as occurs, for example, when the system is not dynamically controlled. Regenerative braking is performed, preferably exclusively, by the electrical machine.

In the oscillations of the oscillating body, there may be instants in which the gravitational force is perpendicular to the degree(s) of freedom of the displacement of the mass with respect to the body, namely, when the oscillating body is not inclined with respect to the horizontal plane, and therefore the gravitational force applied to the mass neither positively accelerate nor decrease the velocity of the mass at these instants but, on the contrary, merely keeps the instantaneous velocity of the displacement of the mass constant at these instants. In the rest of the instants of the oscillations, it is desirable that the gravitational force positively accelerates the instantaneous velocity of the displacement of the mass to maximize the generation of electrical energy.

In some embodiments, the force applied, by the electrical machine, to the mass is controlled by means of an electromagnetic torque adjustment command of the electrical machine, this command being generated by the controller. Since the force applied, by the electrical machine, to the mass can be easily related to such electromagnetic torque, this control of the force applied by the electrical machine to the mass is relatively simple.

The measurement of the instantaneous angle of inclination of the oscillating body can be obtained directly by a sensor (e.g., by an inclinometer) and/or can be calculated from measurements obtained by a sensor (e.g., an accelerometer). The instantaneous angle measured is an angle that varies, due to the oscillations of the body, with respect to the direction of the gravitational force applied to the mass.

The measurement of the instantaneous position of the mass can be obtained directly by a sensor (e.g., a rotary encoder) and/or can be calculated from measurements obtained by a sensor (e.g., a tachometer).

The measurement of the instantaneous velocity of the displacement of the mass can be obtained directly by a sensor (e.g., a tachometer) and/or can be calculated from measurements obtained by a sensor (e.g., a rotary encoder).

The measured instantaneous angle of inclination is of the same instant as the at least one of: instantaneous position of the mass and instantaneous velocity of displacement of the measured mass(es).

In some embodiments, the control objective is that, at all instants of the oscillations, the instantaneous velocity of the displacement of the mass is proportional to the subtraction of the instantaneous angle of inclination of the oscillating body minus the angle of inclination of the body at rest. It has been found that this control objective, in which the instantaneous velocity is proportional to the subtraction of the instantaneous angle of inclination of the oscillating body minus the angle of inclination of the body at rest, allows maximizing the electrical energy generation from oscillations of an oscillating body under certain oscillation conditions, such as, for example, an oscillation caused by waves in a volume of water in which the oscillating body floats.

The angle of inclination of the body at rest is the angle of inclination of the body when the body is not oscillating (e.g., when the body is merely floating in calm water, i.e., without waves). While in some embodiments it is desirable that the angle of inclination of the body at rest is zero, this angle is considered in the control objective because it is possible that this angle is not-zero.

The angle with respect to the plane perpendicular to the direction of the gravitational force is the angle with respect to the gravitational force minus ninety sexagesimal degrees.

In order to adjust the torque, a control algorithm is used with inputs such as, for example, the instantaneous angular position of a rotor of the electrical machine and the instantaneous angle of inclination of the oscillating body in the degree(s) of freedom of the displacement of the mass with respect to the oscillating body (e.g., the instantaneous angle of inclination of the heeling of the oscillating body if the mass can move with respect to the oscillating body in a line perpendicular to the wave front). Thus, if, for example, the displacement of the mass is limited to a straight path, perpendicular to the wave front, and the instantaneous angle of inclination of said path, caused by the heeling of the oscillating body, as well as the instantaneous position of the mass are measured, the control objective may be that the instantaneous velocity of the displacement of the mass is always proportional, and of opposite sign, to the subtraction of the instantaneous angle of the heeling minus the heeling angle of the body at rest.

In some embodiments, the control objective is:

$${\dot{x}}^{′} = - a \cdot ( ϕ - {ϕ}_{0} ) \qquad ( 1. )$$

wherein:
x′: is the instantaneous velocity of the displacement of the mass,
φ: is the instantaneous angle of inclination of the oscillating body,
φ₀: is the angle of inclination of the body at rest, and
a: is an adjustable parameter.

The negative sign of equation (1.0) indicates that the instantaneous velocity of the displacement of the mass x′ has the sense of decreasing heights of a slope having the instantaneous angle of inclination of the oscillating body, from which the inclination of the body at rest has been subtracted, φ-φ₀. This can be seen, as an example, in FIG. 1, where the component of gravity applied to the mass, along its degree of freedom of movement, is represented Fgx′=−m g sin(φ), where m is the magnitude of the mass and g is the value of the acceleration caused by gravity. If it is taken into account that the sine of the instantaneous angle of inclination of the oscillating body always has the same sign as such angle (considering an angle between zero and 2π radians) and it is assumed that the control objective given by equation (1.0) is met without error, it becomes evident that gravity does not slow down the movement of the mass at any instant of the oscillation, except in those instants in which the absolute value of the subtraction of the instantaneous angle of inclination of the oscillating body minus the angle of inclination of the body at rest |φ−φ₀| is less than the absolute value of the angle of inclination of the body at rest |φ₀| and, furthermore, the subtraction of the instantaneous angle of inclination of the oscillating body minus the angle of inclination of the body at rest φ−φ₀ has opposite sign to the sign of the angle of inclination of the body at rest φ₀.

Logically, the electrical energy to be extracted depends on the value of the adjustable parameter a. The adjustable parameter a can also be named adjustable proportionality factor. An appropriate value of the adjustable parameter a allows to conveniently bound the range of the displacement of the mass and the range of instantaneous velocity of the displacement of the mass on the basis of characteristics of the oscillations of the body. Once the mechanical coupling between the oscillating body and the mass has been defined, it is also possible to calculate, on the basis of the chosen adjustable parameter a and the characteristics of the oscillations of the body, the maximum torque applicable by the electrical machine for the implementation of the control objective.

In some embodiments, the oscillatory movements of the body inclination are at least temporarily and/or approximately periodic. That is, the evolution in time of the instantaneous angle of inclination can be defined, at least temporally and/or approximately, as an angle that constitutes a periodic signal in time, of period T, which, therefore, satisfies that:

$$ϕ = ϕ ( t ) = ϕ ( t + T ) = ϕ ( t + n \cdot T )$$

being:

$$T = \frac{1}{ω} ,$$

the fundamental period (eigenperiod) of the angle of inclination,
ω the frequency of the principal component of the angle of inclination,
n any integer, and
t is the time.

Assuming also now that the mean value of the angle of inclination φ, calculated at any instant of time t₀, and described by

$${ϕ}_{0} = {ϕ}_{m e a n} = \frac{1}{T} {\int }_{{t}_{0}}^{{t}_{0} + T} ϕ ( t ) \cdot dt$$

it is defined as the time-constant component of the angle of inclination, also called the angle of inclination of the body at rest φ₀.

In embodiments of the invention in which the above assumption about the periodic oscillation of the body can be found to be at least approximately and/or temporally correct, the application of the control objective described by expression (1.0) can achieve, in addition to the energy extraction, a movement of the mass confined in a bounded path. This is easily deduced by integrating the expression (1.0), after substituting therein the definitions of φ y φ₀ given for the case of periodic oscillations, since, by doing this, we obtain a bounded expression for the position of the movable mass. Achieving that the movement of the mass is bounded may have practical importance in some embodiments of the invention. It may also be very practical, in some embodiments, to be able to calculate in advance the characteristics of such a bounding as a function of the adjustable parameter of the control objective (1.0).

In some embodiments, the control objective is based on the instantaneous velocity of the displacement of the mass, the instantaneous angle of inclination of the oscillating body, the angle of inclination of the body at rest, an oscillation frequency of the oscillations of the oscillating body, a maximum of an absolute value of the subtraction of the instantaneous angle of inclination of the oscillating body minus the angle of inclination of the body at rest, a predetermined maximum longitude of the displacement of the mass, and a predetermined maximum absolute value of the instantaneous velocity of the displacement of the mass. These parameters allow defining the control objective, executing the control, and adjusting it to the oscillations and to the capacities of a system that implements the conversion of the mechanical energy of the oscillations into electrical energy, allowing maximizing the conversion of mechanical energy into electrical energy. As indicated below, the same control objective can be defined/implemented in different ways.

The predetermined maximum longitude of the displacement of the mass is a maximum longitude that the mass can be displaced relative to a central position of the mass in the oscillating body. This predetermined maximum longitude is limited, for example, by the mechanical coupling of the mass with the body (e.g., the predetermined maximum longitude may be half of the total longitude of one of the guides of the displacement of the mass).

To avoid damaging the devices used perform the method of the first aspect of the invention, the absolute value of the instantaneous velocity of the displacement of the mass should not exceed the predetermined maximum absolute value of the instantaneous velocity of the displacement of the mass. The predetermined maximum absolute value of the instantaneous velocity is limited, for example, by mechanical couplings and/or by a predetermined maximum rotational velocity of the rotor of the electrical machine.

In some embodiments (particularly where the fundamental component of the angle of inclination can be assumed, at least approximately and/or temporally, to be periodic and described as a harmonic function, plus a time-constant angle of inclination) the adjustable parameter a satisfies that:

$$a \leq \frac{{\vert {\dot{x}}^{′} \vert}_{max}}{A} \qquad ( 2. )$$

$$a \leq \frac{{\vert {x}^{′} \vert}_{max} \cdot ω}{A ( 1 + \vert C \vert )} \qquad ( 3. )$$

$$a > 0 \qquad ( 4. )$$

wherein:
   |\dot{x}′|ₘₐₓ: is the predetermined maximum absolute value of the instantaneous velocity of the displacement of the mass,
   |x′|ₘₐₓ: is the predetermined maximum longitude of the displacement of the mass,
ω: is the oscillation frequency of the oscillations of the oscillating body,
C: is a constant value with respect to time, which depends on the instantaneous position of the mass at t=0, and
A: is an amplitude of the instantaneous angle of inclination of the oscillating body (specifically, a maximum amplitude of the time-varying part of the instantaneous angle of inclination of the oscillating body), satisfying the instantaneous angle of inclination of the oscillating body, at least approximately, which can be described as a harmonic function, plus a constant angle in time:

$$ϕ = A \cdot sin ( ω \cdot t ) + {ϕ}_{0} \qquad ( 5. )$$

where t is the time.

As can be deduced from equation (5.0), a periodic, harmonic, and regular oscillation has been considered, at least approximately and/or temporally.

To find the range of values of the adjustable parameter a, a maximum amplitude of the time-varying part of the instantaneous angle of inclination of the oscillating body, the predetermined maximum absolute value of the instantaneous velocity of the displacement of the mass and the predetermined maximum longitude of the displacement of the mass can be considered.

Inequations (2.0) and (3.0) are derived from embodiments in which the instantaneous angle of inclination of the oscillating body can be defined by equation (5.0).

Specifically, the inequation (2.0) is deduced by substituting (5.0) into (1.0) and considering the instants of the oscillation where the absolute value of the instantaneous velocity of the displacement of the mass is maximum (sin(ω·t)=±1), as follows:

$${\dot{x}}^{′} = - a \cdot ( ϕ - {ϕ}_{0} ) = - a \cdot A \cdot sin ( ω \cdot t ) \to {\vert {\dot{x}}^{′} \vert}_{max} = {a}_{max} \cdot A \to a \leq \frac{{\vert {\dot{x}}^{′} \vert}_{max}}{A}$$

Specifically, the inequation (3.0) is deduced by integrating equation (1.0) with respect to time, once equation (5.0) has been substituted into it:

$${x}^{′} = \int {\dot{x}}^{′} \cdot dt = \int - a \cdot A \cdot sin ( ω \cdot t ) \cdot dt = \frac{a \cdot A}{ω} \cdot cos ( ω \cdot t ) - \frac{a \cdot A}{ω} \cdot C \qquad ( 6. )$$

where C is a constant that depends on the initial position (for t=0) of the mass. Then, in equation (6.0) are considered the instants of the oscillation when the magnitude of the displacement longitude of the mass is maximum (cos(ω·t)=+1, if C<0; cos(ω·t)=−1, if C>0; and cos(ω·t)=±1, if C=0), and thus obtain the inequation (3.0):

$${\vert {x}^{′} \vert}_{max} = \frac{{a}_{max} \cdot A}{ω} + \frac{{a}_{max} \cdot A}{ω} \cdot \vert C \vert \to a \leq \frac{{\vert {x}^{′} \vert}_{max} \cdot ω}{A \cdot ( 1 + \vert C \vert )}$$

Thus, a value of the adjustable parameter a is chosen that satisfies the inequations (2.0) and (3.0). Within the ranges defined by inequations (2.0) and (3.0), if higher values of a are chosen, more electrical power can be extracted, but a more powerful electrical machine is also needed, as the dynamics are more aggressive.

In some embodiments, the control objective is defined as:

$${x}^{′} = {a}^{′} \cdot ( \dot{ϕ} - A \cdot ω \cdot C ) \qquad ( 7. )$$

wherein:
x′: is the instantaneous position of the mass,
\dot{φ}: is a derivative with respect to time of the instantaneous angle of inclination of the body, and

$${a}^{′} = \frac{a}{{ω}^{2}} \qquad ( 8. )$$

That is, a′ is an adjustable parameter that satisfies the following three inequations:

$${a}^{′} \leq \frac{{\vert {\dot{x}}^{′} \vert}_{max}}{A \cdot {ω}^{2}} \qquad ( 9. )$$

$${a}^{′} \leq \frac{{\vert {x}^{′} \vert}_{max}}{A ( 1 + \vert C \vert ) \cdot ω} \qquad ( 10. )$$

$${a}^{′} > 0 \qquad ( 11. )$$

Equation (7.0) can be deduced from an equation resulting from applying the derivative with respect to time to the two terms of equation (5.0), then substituting into equation (6.0), as follows:

$$ϕ = A \cdot sin ( ω \cdot t ) + {ϕ}_{0} \to \dot{ϕ} = A \cdot ω cos ( ω \cdot t ) \to cos ( ω \cdot t ) = \frac{\dot{ϕ}}{A \cdot ω}$$

$${x}^{′} = \frac{a \cdot A}{ω} \cdot cos ( ω \cdot t ) - \frac{a \cdot A}{ω} \cdot C = \frac{a \cdot \dot{ϕ}}{{ω}^{2}} - \frac{a \cdot A}{ω} \cdot C$$

Considering equation (8.0), we have equation (7.0):

$${x}^{′} = {a}^{′} \cdot \dot{ϕ} - {a}^{′} \cdot A \cdot ω \cdot C = {a}^{′} \cdot ( \dot{ϕ} - A \cdot ω \cdot C )$$

The constant C of equation (7.0) for regular oscillations of the body can be used, making C≠0, to ensure that the movement of the mass is not centered on x′=0, i.e., the maximum distance that the mass reaches with respect to x′=0 is not the same on the positive X′ semi-axis as on the negative one. This may be useful to reduce, in some implementations, the angle of inclination of the body at rest. φ₀. However, doing so causes a reduction of the possible stroke of the displacement of the mass, as can be deduced from inequations (3.0) and/or (11.0).

The same control objective (e.g., the control objective in equation (1.0)) can be defined/implemented in different ways: for example, it can be defined/implemented by equation (1.0) or by equation (7.0).

Logically, \dot{x}′ is the derivative with respect to time of x′.

Logically, a maximum amplitude of the time-varying part of the instantaneous angle of inclination of the oscillating body φ-φ₀ (A) and an oscillation frequency of the oscillations of the body ω in each situation, as well as the constructive limits of the system (e.g., the predetermined maximum absolute value of the instantaneous velocity of the displacement of the mass and the predetermined maximum longitude of the displacement of the mass) are used to determine the adjustable parameters a either a′ in an appropriate manner. In some embodiments, the adjustment of the adjustable parameters a either a′ is performed automatically (i.e., without requiring the participation of a person) by the controller.

In some embodiments, the control objective is based on a maximum electromagnetic torque applicable by the electrical machine or, alternatively, a maximum electromagnetic torque applicable by the electrical machine is based on the control objective.

In some embodiments, the electrical machine is suitable for applying a maximum electromagnetic torque depending on the adjustable parameter a. Thus, the electrical machine is sized to apply the torque necessary to achieve the control objective based on a predetermined adjustable parameter a.

In some embodiments, the adjustable parameter a is based on the maximum electromagnetic torque applicable by the electrical machine. Thus, it is possible to minimize the risk that the maximum torque adjusted by the controller, when adjusting the force applied by the electrical machine to the mass, exceeds the maximum electromagnetic torque applicable by the electrical machine for a predetermined adjustable parameter a.

In some embodiments, the maximum torque adjustable by the controller is limited. This avoids exceeding the maximum torque which, for example, is the maximum electromagnetic torque applicable by the electrical machine.

In some embodiments, the body is floating in water and the oscillations of the body are caused by water waves. It has been found that the control objective is particularly suitable for maximizing the conversion of wave energy into electrical energy and, as an additional and secondary effect, stabilizing the floating body subjected to waves.

A physical meaning of the control objective associated with equations (1.0) and (7.0) can be explained as follows, considering C=0 and φ₀=0 so that the explanation gains clarity. When the instantaneous angle of inclination of the body is maximum in absolute value and the derivative with respect to time of the instantaneous angle of inclination is zero, the mass is at the center of the displacement path of the mass, and the mass has a maximum instantaneous velocity. When the instantaneous angle of inclination of the body is zero and the derivative with respect to time of the instantaneous angle of inclination is maximum, the mass is at the farthest point from the center of the mass path during the displacement. This causes the inclination movement of the structure to lift repeatedly the mass twice for each oscillation cycle from a horizontal plane, while the first aspect of the invention is responsible for braking said mass for most of the time, since the mass movement is never slowed by gravity, as long as the control objective is met. This does not mean that the electrical machine should not push, in certain cases, the mass during certain instants of the oscillation, in which the gravity component is insufficient to make the mass follow the dynamics described by the control objective. For this reason, the electrical machine coupled to the mass is almost always working as an electric generator (in regenerative braking), converting mechanical power into electrical power, but there may be instants in which the electrical machine works as a motor, mainly when the adjustable parameters (a o a′), also called adjustable proportionality factors, used are large. In this sense, the greater the adjustable parameter, the greater the electrical power generated, although a greater adjustable parameter requires a greater electromagnetic torque to control the dynamics of the mass and, consequently, a larger electrical machine.

The fraction of time in which the electrical machine, acting as a motor, accelerates positively the mass may be due (without considering here the effect of the angle of inclination of the body at rest) to the fact that, due to the inertia of the mechanical system and friction, it cannot be guaranteed that the positive acceleration provided by gravity at each instant is sufficient to achieve that the mass follows the desired movement setpoint. The duration of the time intervals of electrical power consumed by the electrical machine may depend on the displacement elongation (which, in turn, depends on the adjustable parameter a of the control objective) of the mass, the total inertia of the mechanical system, the friction and the characteristics of the disturbance that causes the oscillation at each instant. In any case, it is possible to make this duration small in comparison with the duration of the time intervals of generated electrical power (see FIG. 8, for example), thus achieving a high conversion performance of kinetic energy into electrical energy.

It is evident that the performance achieved in the conversion depends on how faithfully the controller makes the mass follow the behavior described by equation (1.0) or (7.0). Therefore, it is desirable to use a controller capable of optimally managing the dynamics of a system with high inertias, multiple possible inputs, and control objectives while it is subjected to disturbances to which the control action must be coupled.

In some embodiments, the method comprises measuring a height of a wave before the wave reaches the body; and the controller is configured to adjust the force applied, by the electrical machine, on the basis of the measurement of the wave height. Thus, the controller is configured to adjust the force applied, by the electrical machine, on the basis of a combination of the measurement of the wave height, the measurement of the instantaneous angle of inclination of the oscillating body and the at least one of: the measure of an instantaneous position of the mass with respect to the oscillating body and the measurement of an instantaneous velocity of the displacement of the mass. Measuring a wave height in advance of the arrival of the wave to the body allows knowing in advance the moment that the wave will cause in the body, avoiding the need to perform complex calculations that require a relatively long time to estimate such moment, thus allowing to improve achievement of the control objective by reducing control errors.

A second aspect of the present invention relates to a system for converting mechanical energy from oscillations into electrical energy, the system comprising an oscillating body, an electrical machine, a mass, a controller, a mechanical coupling of the mass with the body, and a mechanical coupling of the mass with the electrical machine, the mechanical coupling of the mass with the electrical machine being so that the electrical machine generates electrical energy from the displacement of the mass with respect to the body, allowing the mechanical coupling of the mass with the body a displacement of the mass with respect to the body caused by a gravitational force and by a force of the electrical machine applied to the mass; the system being configured to adjust the displacement of the mass by means of an adjustment of the force applied by the electrical machine to the mass; the controller being configured to adjust the force applied by the electrical machine on the basis of a measurement of an instantaneous angle of inclination of the oscillating body and on the basis of at least one of: a measurement of an instantaneous position of the mass with respect to the oscillating body and a measurement of an instantaneous velocity of the mass with respect to the oscillating body; and the controller being configured so that a control objective of the adjustment of the force applied by the electrical machine is to achieve that an instantaneous velocity of the displacement of the mass is positively accelerated by the gravitational force applied to the mass at all instants of the periodic oscillations in which:
the subtraction of the instantaneous angle of inclination of the oscillating body minus the angle of inclination of the body at rest has opposite sign to the sign of the angle of inclination of the body at rest, and the absolute value of the subtraction of the instantaneous angle of inclination of the oscillating body minus the angle of inclination of the body at rest is greater than the absolute value of the angle of inclination of the body at rest; and/or
the subtraction of the instantaneous angle of inclination of the oscillating body minus the angle of inclination of the body at rest has the same sign than the angle of inclination of the body at rest;
the instantaneous angle of inclination being an angle with respect to a plane perpendicular to the direction of the gravitational force (Fg), and the angle of inclination of the body at rest being an angle with respect to the plane perpendicular to the direction of the gravitational force (Fg).

In some embodiments, the mass comprises the electrical machine. Thus, the mass of the electrical machine is used as a movable mass.

In some embodiments, the mechanical coupling of the oscillating body with the mass comprises a mechanical coupling of the mass with straight guides and an gear of a rack with a sprocket; a center of the sprocket being mechanically connected to a rotary shaft perpendicular to the sprocket; the rotary shaft being mechanically connected to a rotor of the electrical machine; and a stator of the electrical machine being integral with the mass. This coupling allows minimizing vibrations due to the flexibility of mechanical coupling components. Vibrations due to such flexibility can reduce the useful life of the mechanical transmission itself, the electrical machine, and its power electronics. However, it is unlikely that they would have an impact on either the power generated or the stability of the body, as these vibrations are normally of much higher frequency than the oscillating movement of the body.

The stator is integral with the mass in the sense that it moves with the mass along the guides. Preferably, the rotation of the sprocket is transmitted to the rotor and is not transmitted to the stator.

In some embodiments, the rotary shaft is mechanically connected to a multiplier mechanism and/or to an inertia flywheel, with the multiplier mechanism and/or the inertia flywheel being sandwiched between the sprocket and the rotor. The multiplier mechanism allows the sprocket to rotate at a slower velocity than the rotor. The inertia flywheel allows to increase the moment of inertia of the system.

In some embodiments, the method of the first aspect of the present invention is performed with the system of the second aspect of the present invention.

A third aspect of the present invention relates to a system comprising an oscillating body, an electrical machine, a mass, mechanical couplings, and a controller configured to perform the method of the first aspect of the present invention.

The different aspects and embodiments of the invention defined above may be combined together, provided that they are mutually compatible.

Additional advantages and features of the invention will become apparent from the detailed description that follows and will be particularly indicated in the attached claims.

### BRIEF DESCRIPTION OF THE DRAWINGS

As a complement to the description, and for the purpose of helping to make the features of the invention more readily understandable, in accordance with practical exemplary embodiments of the invention, said description is accompanied by a set of figures which, by way of illustration and not limitation, represent the following:

FIG. 1 schematically shows a mass movable along the virtual axis X′ and on which a gravitational force acts according to the present invention.

FIG. 2 schematically shows a possible mechanical coupling of the mass with the oscillating body according to the present invention.

FIG. 3 shows a time evolution of various parameters of a system without an electrical machine mechanically coupled to the mass.

FIG. 4 shows a time evolution of various parameters of a system with an electrical machine mechanically coupled to the mass, but which does not apply any electromagnetic torque to its rotor.

FIG. 5 shows a time evolution of various parameters of a system, according to the present invention, which has an electrical machine mechanically coupled to the mass, and applies electromagnetic torque to control the dynamics of the system.

FIG. 6 shows a time evolution of the exciting moment that causes the waves on a vessel of a system according to the present invention, as well as an estimate of such moment implemented to assist the controller in the implementation of the proposed control objective.

FIG. 7 shows a time evolution of various parameters of a system according to the present invention related to electric power generation.

FIG. 8 shows a time evolution of the electrical power consumed/generated by the electrical machine of a system, according to the present invention.

Each of FIGS. 9A and 9B shows a time evolution of the electrical energy generated by the electrical machine of a system, according to the present invention.

FIG. 10A shows a time evolution of an instantaneous heeling angle of a system, without applying mass dynamics control, according to the present invention.

FIG. 10B shows a time evolution of an instantaneous heeling angle of a system applying mass dynamics control, according to the present invention.

### DESCRIPTION OF EMBODIMENTS OF THE INVENTION

In the description of the possible embodiments of the invention, numerous details must be provided to favor a better understand of the invention. Even so, it will be apparent to the person skilled in the art that the invention can be implemented without these specific details. On the other hand, well-known features have not been described in detail to avoid unnecessarily complicating the description.

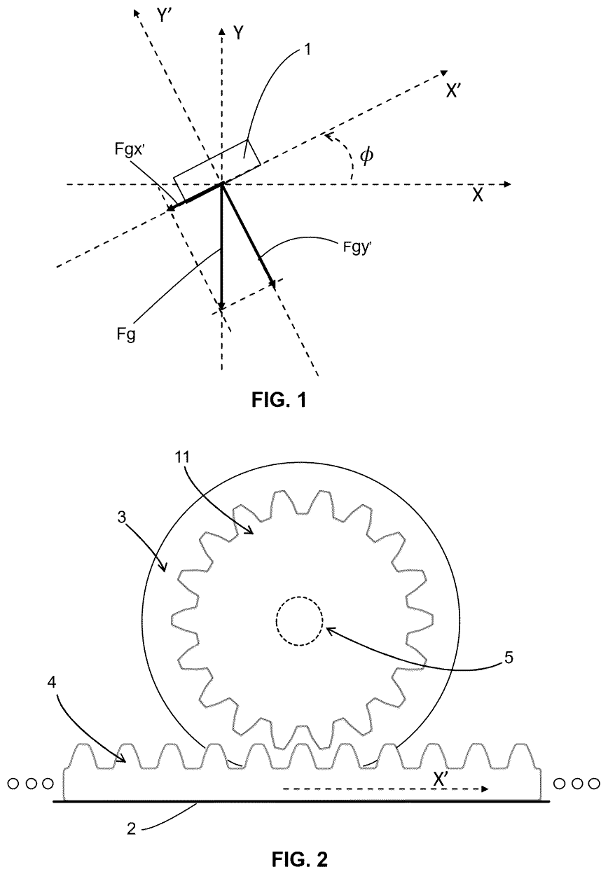

FIG. 1 shows a mass 1 of magnitude m, movable along a virtual axis X′ of a reference system formed by the virtual axes X′ and Y′, integral with the oscillating body. The mass 1 is mechanically coupled to an oscillating body that, in this specific example of application, floats in water. Neither the body nor the mechanical coupling is shown in FIG. 1, although the body has an inclination defined by the instantaneous angle of inclination of the oscillating body φ, and this angle of inclination varies due to the oscillations of the body caused by waves of the water volume in which the body floats.

FIG. 1 also shows an inertial reference system formed by the virtual X and Y axes. The virtual axis X is coincident with the virtual axis X′ when the instantaneous angle of inclination of the oscillating body φ is zero.

As shown in FIG. 1, when the body is tilted at an angle φ with respect to the virtual axis X, the gravitational force Fg applied to the mass 1 can be decomposed into vector components Fgx′ and Fgy′, perpendicular to each other.

$${Fgx}^{′} = - m \cdot g \cdot sin ( ϕ )$$

$${Fgy}^{′} = - m \cdot g \cdot cos ( ϕ )$$

As the mass 1 is movable, with respect to the body, along the virtual axis X′, the vector component Fgx′ causes, at all the instants in which the instantaneous angle of inclination of the oscillating body φ is non-zero, a positive acceleration of the mass 1 (in the sense that the displacement velocity of the mass 1 increases) parallel to the virtual axis X′ and of value −g sin(φ). Thus, the oscillation of the body (which causes the variation of the angle φ with respect to time) causes a time-varying vector component Fgx′ of the gravitational force Fg which, obviously, affects the displacement of the mass 1 with respect to the body.

FIG. 2 shows an example of the mechanical coupling of the mass 1 with a body portion 2, using a mechanical transmission and an electrical machine 3. Specifically, the mechanical transmission may comprise a sprocket 11 that meshes with a rack 4 forming a rack-pinion joint. The rack 4 is aligned with the virtual axis X′. The rack 4 is supported by the body portion 2 and is fixed with respect to the body portion 2, so that the rack 4 tilts in the same way as the body in the oscillations. Thus, when the body portion 2 oscillates, the rack 4 also oscillates.

In addition to the rack 4, the mechanical coupling of the mass 1 with the body portion 2 may comprise fixed guides (not illustrated) with respect to the body, the mass 1 being coupled to the guides such that the guides guide the movement of the mass 1 in the displacement of the mass with respect to the body in the oscillations. The guides are supported by the body portion 2 and are fixed with respect to the body portion 2, so that the guides tilt in the same way as the body in the oscillations.

The guides are parallel to the virtual axis X′. Thus, when the body portion 2 oscillates, the guides also oscillate. The guides include, for example, rails; and the mass 1 comprises wheels mechanically attachable to the rails of the guide.

Continuing with FIG. 2, the sprocket 11 is connected to a rotor of the electrical machine 3 by means of a shaft 5, perpendicular to the sprocket 11. One end of the shaft 5 is attached to the center of the sprocket 11 and the other end of the shaft 5 is attached to the center of the rotor of the electrical machine 3. Finally, the frame (stator) of the electrical machine 3 is integral with the displacement of the mass 1 along the guides. Thus, the linear displacement of the mass 1 along the guides parallel to the axis X′ is converted into angular displacement of the rotor of the electrical machine 3, by means of the rotation of the sprocket 11 and of the shaft 5; the shaft 5 being integral with the sprocket 11. The electrical machine 3 can generate electrical energy from said rotation of the rotor of the electrical machine 3, causing deceleration of the rotor, the shaft 5 and the mass 1. The electrical machine can also consume electrical energy to accelerate the movement of the rotor, the shaft 5 and the mass 1, by positively accelerating the angular velocity of rotation of the rotor of the electrical machine 3.

Although in this example the sprocket 11 is connected to the rotor of the electrical machine 3 directly by means of the shaft 5, in other embodiments the mechanical coupling can incorporate in the shaft 5 a multiplier mechanism sandwiched between the sprocket 11 and the rotor of the electrical machine 3, so that the angular velocity of rotation of the sprocket 11 can be lower than the angular velocity of rotation of the rotor of the electrical machine 3. In some embodiments, the mechanical coupling can incorporate in the shaft 5 an inertia flywheel sandwiched between the sprocket 11 and the rotor of the electrical machine 3 to increase the moment of inertia of the system. Obviously, the two optional incorporations mentioned can be made simultaneously or separately.

The mass 1 and the oscillating body can be coupled by means of mechanical couplings other than the rack-pinion joint illustrated in FIG. 2. For example, the mechanical coupling of the mass 1 with the body may comprise, in addition to parallel guides of the axis X′, pulleys coupled to a common belt attached, on both sides, to the mass 1. Thus, the displacement of the mass 1 causes a displacement of the belt, this displacement of the belt causing the rotation of the pulleys. If at least one of the pulleys is mechanically coupled to the rotor of an electrical machine in an integral manner, the rotation of the pulley caused by the displacement of the mass 1 will cause the rotation of the rotor of the electrical machine. Thus, by controlling the angular rotation of the rotor, the dynamics of the mass 1 can be adjusted, while electrical energy can be extracted or consumed from the electrical machine 3.

The electrical machine 3, by converting kinetic energy of the mass 1 into electrical energy and by converting electrical energy into kinetic energy of the mass 1, applies a force to the mass 1, modifying the acceleration of the mass 1 and consequently the future velocity and positions of the mass 1. The force applied by the electrical machine to the mass 1 can be controlled by a controller that makes it possible to adjust the electromagnetic torque applied to the rotor of the electrical machine 3. For example, a current and/or voltage of the rotor and/or stator of the electrical machine 3 can be adjusted. Thus, the controller can adjust the force applied to the mass 1 and, at the same time, makes it possible to adjust the instantaneous electrical power generated and/or consumed by the electrical machine 3.

To maximize the obtaining of electrical energy from the displacement of the mass 1 due to the oscillating movement of the body, the controller is configured so that a control objective of the adjustment of the force applied by the electrical machine to the mass 1 is to achieve, at all instants of the oscillations, a movement of the mass 1 positively accelerated by the gravitational force Fg applied to the mass 1 or a movement of the mass 1 perpendicular to the gravitational force Fg applied to the mass 1 (considering, to give clarity to this example of application, that, in this particular case, the angle of inclination of the body at rest φ₀ is zero). For example, at the instant of oscillation illustrated in FIG. 1, the control objective is to achieve a movement of the mass 1 in the negative direction of the virtual axis X′ (i.e., towards the lower part of the slope of the virtual axis X′), so as to make use of the acceleration that, at that instant, gravity applies to the mass 1.

To achieve the control objective, at instants of oscillations, the movement of the mass 1 is adapted to the oscillations of the body by means of a control based on parameters of the oscillations and the movement of the mass. Thus, the control can be implemented by adjusting the force applied, by the electrical machine 3, through a mechanical transmission, to the mass 1 on the basis of measurements of instantaneous angles of inclination of the oscillating body and on the basis of at least one of: measurements of instantaneous positions of the mass with respect to the oscillating body and measurements of instantaneous velocities of the displacement of the mass with respect to the oscillating body.

Logically, the controller may be additionally configured to protect the electrical machine and its power electronics from excessively high electromagnetic torques (and therefore, for example, from excessively high currents). Logically, the force that positively accelerates the mass 1 does not have to be exclusively the gravitational force Fg, for example, it can also be a force applied by the electrical machine 3.

The control objective can be implemented (considering that the angle of inclination of the body at rest φ₀ is zero), for example, as:

$${\dot{x}}^{′} = - a \cdot ϕ$$

Or, alternatively, when the oscillation undergone by the body can be considered periodic, harmonic, and regular, as:

$${x}^{′} = {a}^{′} \cdot ( \dot{ϕ} - A \cdot ω \cdot C )$$

$$wherein :$$

$${a}^{′} = \frac{a}{{ω}^{2}}$$

being:
\dot{x}′: is the instantaneous velocity of the displacement of the mass,
φ: is the instantaneous angle of inclination of the oscillating body,
x′: is the instantaneous position of the mass,
\dot{φ}: is a derivative with respect to time of the instantaneous angle of inclination of the body,
ω: is an oscillation frequency of the oscillations of the body,
C: is a value, constant with respect to time, which depends on the initial conditions defined for the movement of the mass, i.e., the initial position of the mass (i.e., at t=0),
α: is an adjustable parameter that satisfies the following three inequations:

$$a \leq \frac{{\vert {\dot{x}}^{′} \vert}_{max}}{A}$$

$$a \leq \frac{{\vert {x}^{′} \vert}_{max} \cdot ω}{A ( 1 + \vert C \vert )}$$

$$a > 0$$

wherein:
   |\dot{x}′|ₘₐₓ: is a predetermined maximum absolute value of the instantaneous velocity of the displacement of the mass 1,
   |x′|ₘₐₓ: is a predetermined maximum displacement longitude of the mass 1 (e.g., half the longitude of rack 4), and
A: is an amplitude of the instantaneous angle of inclination of the oscillating body, the instantaneous angle of inclination of the oscillating body satisfying, at least approximately, that:

$$ϕ = A \cdot sin ( ω \cdot t )$$

where t is the time.

The instantaneous position of the mass x′ with respect to the body can be defined with a coordinate of the virtual axis X′. This position can be obtained on the basis of measurements of the displacement of the mass 1 in the virtual axis X′, the measurements being obtained by one or more sensors for measuring the displacement of the mass 1, the displacement being in the virtual axis X′ and relative to the oscillating body.

The instantaneous position measurement of the mass x′ can be obtained on the basis of measurements from a sensor to obtain displacement measurements of the mass 1 (e.g., an inertial sensor placed on the mass 1 such as, for example, an accelerometer) and a sensor to obtain displacement measurements of the oscillating body (e.g., an inertial sensor placed on the oscillating body such as, for example, an accelerometer). Thus, the displacement, on the virtual axis X′, of the mass 1 relative to the oscillating body can be measured and, on the basis of a predetermined position of the mass 1 and the body at a known instant, the instantaneous position of the mass 1 on the virtual axis X′ at other instants can be calculated.

In another way of obtaining the instantaneous position measurement of the mass x′ measurements from a sensor are used to obtain measurements of rotation of the rotor of the electrical machine 3. This sensor is, for example, a rotary encoder for measuring an angular position and/or an angular velocity of the rotor of the electrical machine 3. The position of the mass on the virtual axis X′ can be calculated from the angular position of the rotor of the electrical machine 3 and from a predetermined position of the mass 1 and the rotor of the machine 3 at a known instant. The velocity of the mass 1 in the virtual axis X′ can be calculated from the angular velocity of the rotor of the electrical machine 3.

The displacement velocity measurement i′ can be obtained on the basis of instantaneous position measurements of the mass 1. For example, it can be obtained by calculating a derivative with respect to time of a mathematical function defining the displacement of the mass 1 on the virtual axis X′. Logically, one way to obtain this mathematical function is based on the position measurements of the mass 1, with the displacement of the mass 1 being relative to the oscillating body and in the virtual axis X′.

The measurement of the instantaneous angle of inclination of the oscillating body φ can be obtained based on measurements from a sensor, the sensor being configured to obtain measurements of angles of inclination of the oscillating body, for example, using a sensor to measure the instantaneous angle of inclination of the oscillating body φ (e.g., using an inclinometer, in particular a digital inclinometer comprising at least one accelerometer and/or at least one gyroscope) placed on the body.

The controller may comprise a memory that stores a computer program. The computer program comprises instructions for implementing the control objective. The controller controls the force applied by the electrical machine to the mass 1 by processing, through the execution of the computer program, the measurements captured by several of the sensors mentioned above.

Specifically, the controller may comprise a processor, a memory that stores the computer program, means for adjusting the torque of the electrical machine (i.e., the moment of force of the electrical machine), communication modules that communicatively connect the processor with the torque adjustment means and with several of the sensors mentioned above. The processor is configured to receive the measurements captured by said sensors through the communication modules. The processor is configured to process such measurements by executing the computer program and to send instructions to the torque adjustment means, the instructions being based on the result of the processing of such measurements.

The person skilled in the art knows various ways to implement the control objective, for example, by PID-type control (i.e., a proportional, integral, and derivative type control) or a model-based predictive control (i.e., a MPC control). For example, a closed-loop control can be implemented in which the reference signal is based on the control objective. For example, the control may comprise calculating at least one of the following error signals and feeding back said at least one error signal to the controller:

$$error signal = {\dot{x}}^{′} + a \cdot ( ϕ - {ϕ}_{0} )$$

$$error signal = {x}^{′} - {a}^{′} \cdot ( \dot{ϕ} - A \cdot ω \cdot C )$$

Logically, the values taken by the adjustable parameters a, a′ affect the magnitude of the signals involved in the control. It is advisable to adjust these values to the system constraints, for example, to the predetermined maximum absolute value of the instantaneous velocity of the displacement of the mass |\dot{x}′|ₘₐₓ on the guides parallel to the virtual axis X′ and to the predetermined maximum longitude of the displacement of the mass |x′|ₘₐₓ. These limitations also depend on the frequency ω and maximum amplitude A of the oscillations that the oscillating body experiences at each instant. Both |\dot{x}′|ₘₐₓ and |x′|ₘₐₓ depend on, among others, the characteristics of the mechanical transmission, the rotating electrical machine, and the dimensions of the oscillating body. Another aspect of the system to take into account when choosing the adjustable parameters a, a′ could be the maximum electromagnetic torque that the electrical machine 3 can apply to the mass 1. However, an alternative would be to set in advance the nominal oscillation range of the body (values of A and ω for which the system can operate safely) and then choose the ranges of the adjustable parameters a, a′ taking into account both |\dot{x}′|ₘₐₓ and |x′|ₘₐₓ. Finally, the maximum torque required could be calculated and, on the basis of this torque, the power of the electrical machine to be used can be selected, considering the possibility of adding a mechanical multiplier and/or an inertia flywheel. Obviously, it can be an iterative design process or one that uses control co-design techniques.

In some embodiments, in which a mechanical transmission of the rack-and-pinion type is used such as, for example, the one in FIG. 2 and which, in this case, does not include an inertia flywheel, when the oscillation of the body can be considered regular (i.e., described by equation (5.0) and the displacement of the mass is centered on the mass path (C=0 in equation (6.0)), a simplified relationship between the torque applied by the electrical machine to the rotor T_{gen} and the adjustable parameter a′ is:

$${T}_{gen} = \frac{m \cdot R \cdot A}{{N}_{gear}} \{ ( g - {a}^{′} \cdot {ω}^{2} \cdot G ) \cdot sin ( ω \cdot t ) - {a}^{′} \cdot {ω}^{3} \cdot F \cdot cos ( ω \cdot t ) \} \qquad ( 13. )$$

$$wherein :$$

$$G = \frac{B}{m} + \frac{{D}_{gen} \cdot {N}_{gear}^{2}}{m \cdot {R}^{2}}$$

$$F = 1 + \frac{{J}_{gen} \cdot {N}_{gear}^{2}}{m \cdot {R}^{2}}$$

m: is the total mass of the mass 1,
R: is a radius of the sprocket (pinion) 11 that is part of the rack-and-pinion type mechanical transmission,
N_{gear}: is a transmission ratio of the multiplier mechanism that mechanically couples the sprocket 11 to the rotor of the electrical machine 3,
g: is the gravitational constant of value 9.8 m/s²,
B: is a friction coefficient between the mass 1 and the guides of the displacement of the mass 1,
D_{gen}: is a friction coefficient of the rotor of the electrical machine 3 with respect to the high-velocity rotation shaft of the multiplier,
J_{gen}: is a moment of inertia of the rotor of the electrical machine 3 with respect to the high-velocity rotation shaft of the multiplier,
t: is the time,
ω: is the oscillation frequency of the oscillations of the oscillating body, and
A: is the instantaneous angle of maximum inclination of the oscillating body according to:

$$ϕ = A \cdot sin ( ω \cdot t ) ( considering {ϕ}_{0} = 0 )$$

where t is the time.

Thus, the maximum torque applied by the electrical machine to the rotor in the displacement can be calculated by deriving with respect to time the equation (13.0) and setting it equal to zero to obtain the instant of time tₑₓₜᵣ in which occurs the local maximum (or minimum) of the highest absolute value of T_{gen}:

$${T}_{gen\_max} = \frac{m \cdot R \cdot A}{{N}_{gear}} \{ ( g - {a}^{′} \cdot {ω}^{2} \cdot G ) \cdot sin ( ω \cdot {t}_{extr} ) - {a}^{′} \cdot {ω}^{3} \cdot F \cdot cos ( ω \cdot {t}_{extr} ) \}$$

$$wherein :$$

$${t}_{extr} = \frac{1}{ω} . ( {tan}^{- 1} \frac{ω \cdot ( {a}^{′} \cdot {ω}^{2} \cdot G - g )}{{a}^{′} \cdot {ω}^{3} \cdot F} )$$

Thus, from previous measurements of the inclination movement of the oscillating body (maximum amplitude A and frequency ω) and tentative values for the construction parameters of the installation (m, B, R, N_{gear}, J_{gen}, D_{gen}), it is possible to calculate, approximately, the maximum torque value T_{gen} max which is desirable for the installed electrical machine to be able to provide, depending on the chosen adjustable parameter a′.

On the other hand, these expressions for T_{gen} max can serve, together with (7.0), (9.0), (10.0) and (11.0), to readjust the adjustable parameter a′ (or from a) depending on the inclination measurements taken during the operation of the system, allowing to avoid that the system breaches some functional limitation (e.g., to avoid excessive displacement of the mass, or excessive displacement velocity of the mass and/or excessive torque of the electrical machine). In any case, the design of the system can be done through an iterative process or from a control co-design (CCD) methodology.

The following example refers to a model-based predictive control (MPC) method using a simplified model based on two non-linear coupled equations, one of which describes the heel, i.e., the instantaneous angle of inclination of the oscillating body φ (e.g., a floating body such as, for example, a vessel) as a function of the waves incident on the body and the movement of the mass 1 mechanically coupled to the body, according to the transmission described in FIG. 2. The other equation describes the movement of the mass 1 as a function of the heel and the force applied to the mass 1 by the electrical machine from the electromagnetic torque (T_{gen}) of the electrical machine controlled with the predictive control method. The controller receives measurements of the angular position of the rotor of the electrical machine 3 and measurements of the heeling angle of the body. The control method incorporates a state observer (e.g., a Kalman filter) to estimate the moment created by the waves on the vessel. This state observer facilitates the synchronization of the movement of the mass 1 with the heel by merely adjusting the electromagnetic torque applied, by the electrical machine, to the mass 1 by means of the mechanical transmission of FIG. 2.

Numerical simulations have been performed to study the performance of the method and system of the invention. In these numerical simulations, a non-linear physical model of the complete system has been used, to which a model-based predictive controller (MPC) has been applied to achieve dynamics according to the control objective of the invention and maximization of electrical energy extraction, keeping all parameters within a nominal range. The aforementioned non-linear model is constituted by the two coupled equations describing, respectively, the inclination of the oscillating body and the movement of the mass 1 coupled to it, taking into account their mutual influence and external disturbances. For its part, the MPC controller uses a simplified (linear) model of the system to predict the dynamic behavior during a recessive time horizon and optimize the control action to achieve the control objective of the invention, taking into account the known system constraints.

If any of the disturbances to which the system is subjected can be measured in advance, these measurements can be included in the prediction (disturbance preview) to anticipate their effects on the dynamics. If a disturbance (or some other state of the system) cannot be measured, the aforementioned state observer is responsible for approximately calculating it from the measured variables of the system and the behavior of the internal model used in the prediction.

In the case of this example, it has been considered that the angle of inclination of the body at rest φ₀ is zero and that we have chosen a movement for the mass bounded and centered on x′=0 (therefore, we have done C=0). It has also been considered that the main excitatory disturbance of the system (the moment created by the waves) is a variable that cannot be measured and, therefore, must be estimated by the aforementioned state observer.

However, by using a buoy positioned at a certain distance from the vessel, the wave height could be measured some time in advance. By calculating the exciting moment from said measurement and the hydrodynamic model of the vessel, the preview of this disturbance can be implemented, which would significantly improve the performance of the control system, by enabling the control action to anticipate the effects of the disturbance. In high inertia systems, such as those of this type, anticipation makes it possible to maximize the yields obtained.

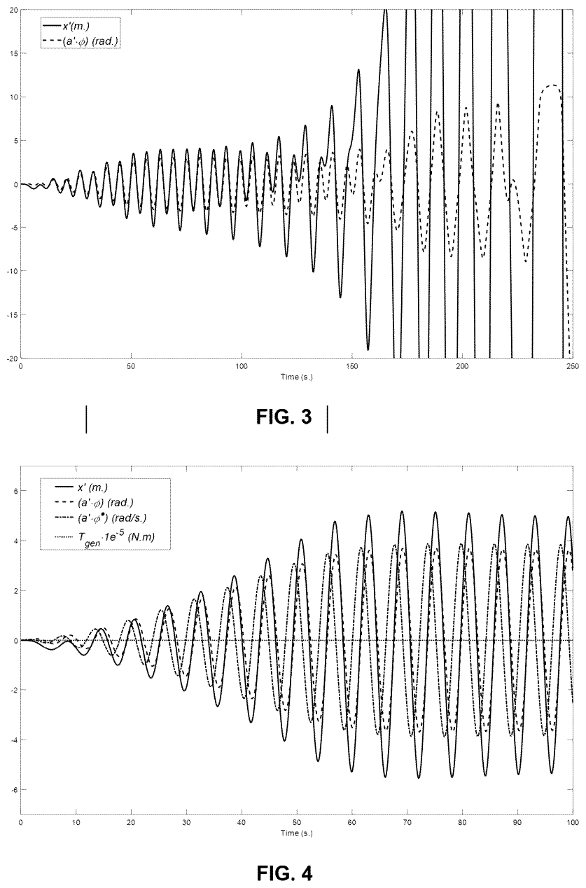

In the following, reference is made to graphs that show the results of the numerical simulations performed. The horizontal axis (i.e., the abscissa axis) of the graphs in FIGS. 3-8, 9A, 9B, 10A and 10B represents time, specifically, seconds.

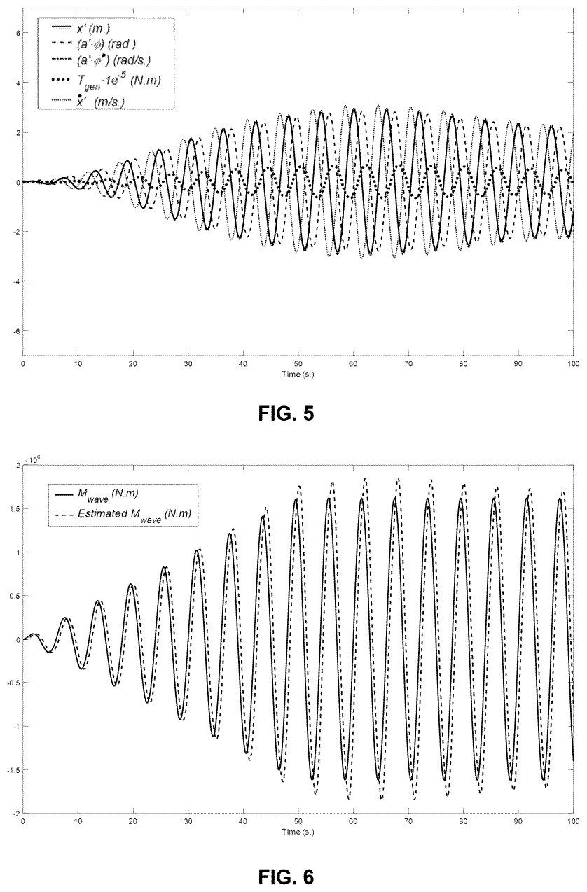

FIG. 3 shows the behavior of a system with a mass 1 not coupled to any electrical machine. FIG. 4 shows the behavior of a system with a mass 1 mechanically coupled, through the transmission of FIG. 2, to an electrical machine 3, but which does not apply any electromagnetic torque to its rotor (i.e., equivalent to adding an inertia flywheel of inertia with constructive parameters J_{gen} and D_{gen}). FIG. 5 shows the behavior of a system with a mass 1 mechanically coupled, through the transmission of FIG. 2, to an electrical machine that applies an electromagnetic torque so that the dynamics of the mass 1 meets the control objective of the present invention (specifically, the control objective of equation (1.0)), allowing the amount of electrical energy extracted to be maximized.

The graphs of FIGS. 3, 4 and 5 show the evolution of the instantaneous position of the mass x′ with respect to the body on the virtual axis X′ and the instantaneous angle of inclination of the oscillating body φ (i.e., the instantaneous heeling angle) multiplied by the adjustable parameter a′ (the adjustable parameter being a′=6 in the graphs of FIGS. 3-8, 9A, 9B, 10A and 10B). This value of the adjustable parameter a′ has been chosen following the general guidelines presented in previous sections. It is also noted that, in this case, initial conditions have been assumed for the system that consider the movement of the mass 1 centered in its path (i.e., C=0).

The graphs in FIGS. 4 and 5 show the evolution of the derivative with respect to time of the instantaneous angle of inclination of the oscillating body \dot{φ} multiplied by the adjustable parameter a′. The evolution of the electromagnetic torque applied, by the stator of the electrical machine 3, to the rotor of the electrical machine 3 has also been represented, T_{gen}.

The graph in FIG. 5 also represents the evolution of the derivative with respect to time of the instantaneous position of the mass x′ with respect to the body.

FIG. 6 shows the evolution of the real value of the exciting moment caused by the waves applied to the oscillating body M_{wave} and the evolution of the estimate, carried out by the state observer (e.g., a Kalman filter), of the exciting moment caused by the waves applied to the oscillating body Estimated M_{wave}.

FIG. 3 shows that, due to the non-linear factors that influence the heel and, therefore, the movement of the mass 1, the instantaneous position of the mass x′ diverges quickly. Once the electrical machine is mechanically coupled to the mass 1 (see FIG. 4), through the coupling illustrated in FIG. 2, the increase in the total moment of inertia due to this coupling exerts a notable stabilizing action. However, since the instantaneous position of the mass x′ is not synchronized with the heeling angle of the vessel, it follows from FIG. 4 that, during approximately half of the period, the signs of the instantaneous velocity of the displacement of the mass 1 (i.e., of the derivative with respect to time of the instantaneous position of the mass 1 with respect to the body) and of the instantaneous angle of inclination of the oscillating body φ are coincident, so that gravity slows down the mass 1 for a large part of each cycle, thus limiting the conversion efficiency of kinetic energy of the mass 1, due to the oscillations of the body, into electrical energy.

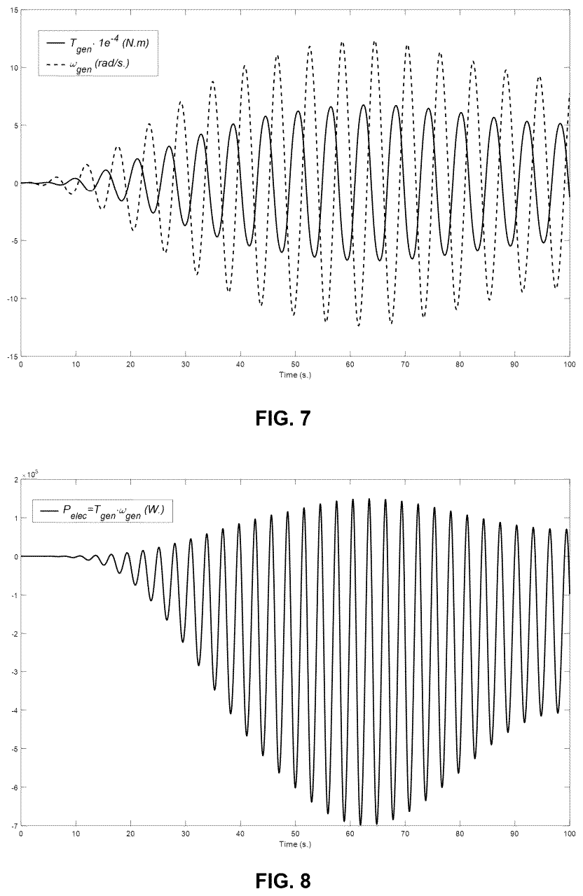

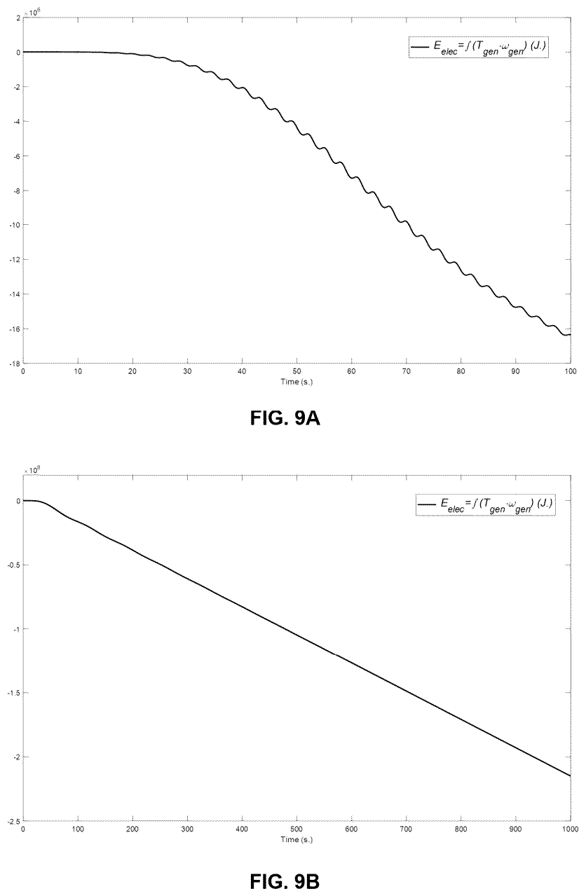

As illustrated in FIG. 5, where the signals of x′ and a′·\dot{φ} appear practically superimposed, the application of MPC control allows the control objective of the present invention (e.g., implementing the control objective assuming initial conditions such that C=0, according to: x′=a′·\dot{φ} or \dot{x}′=−a·φ) to be met, with a very small error. There is, however, a small delay in the tracking (time lag between the evolution of x′ and the evolution of −a. φ, deduced from FIG. 5, which prevents both signals from being exactly in counter-phase), which causes small losses in the conversion of mechanical energy into electrical energy (see FIGS. 7 and 8). This delay is due, among other possible causes, to the fact that the state observer's estimation of the incident wave moment from the simplified linear model, which approximately describes the dynamic behavior of the system, and the heel and position measurements of the mass 1, is neither instantaneous nor accurate (see FIG. 6).

Therefore, if measurements of wave heights were captured prior to the arrival of the waves at the vessel (e.g., using a measurement buoy anchored at a certain distance from the body), the value of the instantaneous exciting moment that the waves are going to cause on the vessel could be calculated in advance, at a certain instant of the prediction horizon, and it would be possible to use this prediction to improve the calculation of the electromagnetic torque setpoint of the electrical machine, making it possible to eliminate this delay and to compensate the ones caused by the high inertia of the system, thus substantially improving the efficiency of the conversion of mechanical energy into electrical energy.

The following includes an analysis of the electrical power generated and the effect on the stability of the vessel. FIG. 7 shows the evolution of the applied electromagnetic torque (multiplied by a reduction factor 1e⁻⁴, to facilitate the comparison of the phase of signals with very different magnitude), by the electrical machine 3, in its rotor (and, therefore, in the shaft 5) T_{gen}. In this example T_{gen} is the only variable controlled by the MPC. Likewise, said FIG. 7 shows the evolution of the angular velocity of the rotor ω_{gen} of the electrical machine 3. It is observed that, during most of the oscillation period, both signals have opposite signs (they are not exactly in counterphase due to the causes discussed in the previous paragraph). Thus, it is confirmed that the electrical machine acts mainly as an electric generator, performing regenerative braking of the mass 1 and generating electric power, since the electric power is the product of the electromagnetic torque applied by the angular velocity of the rotor of the electrical machine 3.

Multiplying the instantaneous electromagnetic torque T_{gen} and the instantaneous angular velocity ω_{gen} of FIG. 7, the instantaneous electrical power of the electrical machine, shown in FIG. 8, can be calculated. Thus, FIG. 8 shows the evolution of the electrical power generated (negative power) and consumed (positive power) by the electrical machine. P_{elec}. As indicated in FIG. 8, the electrical power can be calculated as P_{elec}=T_{gen}·ω_{gen}. In FIG. 8 it can be seen that most of the time the instantaneous electrical power is negative, i.e., the electrical machine generates electrical power. There are small intervals (somewhat more intense during the brief transient) where the machine acts as a motor to achieve the mass meets the objective of dynamic control. This is due, in part, to synchronization errors (already mentioned) between the heel and the movement of the mass and, in part, to the fact that, at certain instants, the force of gravity is not capable of applying, on its own, the necessary positive acceleration to the mass.

By accumulating, i.e., integrating with respect to time, the instantaneous electrical power, the electrical energy generated by the system can be calculated, E_{elec} (see FIGS. 9A and 9B) over time. Said FIGS. 9A and 9B represent the energy (the unit of measurement on the vertical axis is the Joule) generated by the system. It is observed that, after a short transient (approximately one minute), the generation of electrical energy is practically linear. FIG. 9A shows an enlargement of the first hundred seconds of the graph in FIG. 9B. The transient is shown enlarged in FIG. 9A.

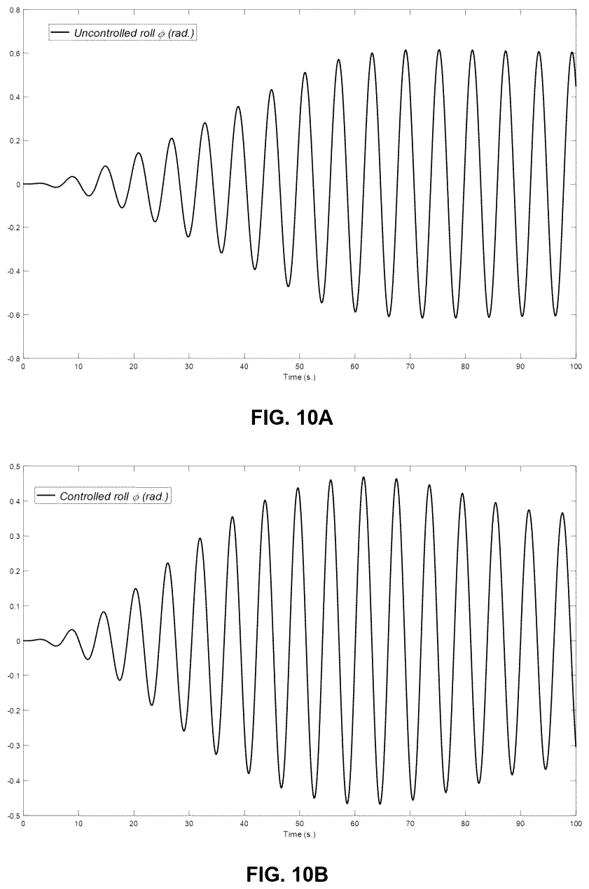

Finally, the impact of the control of the invention on the hydrodynamic stability of the vessel has been analyzed. FIG. 10A shows the evolution of the instantaneous angle of inclination of the oscillating body φ (measured in radians) when the dynamic control of the invention is not applied to the displacement of the mass 1. FIG. 10B shows the evolution of the instantaneous angle of inclination of the oscillating body φ (measured in radians) when applying the dynamic control objective of the present invention (specifically the control objective of equation (1.0)). As can be deduced from FIGS. 10A and 10B, the instantaneous angle of maximum inclination is significantly reduced (almost 50%) when the control is applied, since electrical energy is extracted from the kinetic energy of the oscillating body (through the movement of the mass), causing partial stabilization. It is obvious that said stabilization entails a limit to the extraction of energy from the movement of the oscillating structure, but also, if the structure undergoing the oscillation is not dedicated exclusively to the extraction of energy, it can be a (complementary) objective in itself.

In the present disclosure, the term “instantaneous” when accompanying a term “Z” (such as, for example, “instantaneous Z”) refers to “Z” at a particular instant. For example, the expression “instantaneous position” refers to a position at a specific instant, and the expression “instantaneous velocities” refers to velocities at specific instants of time.

In view of this description and figures, the person skilled in the art may understand that the invention has been described according to some preferred embodiments thereof, but that multiple variations may be introduced in said preferred embodiments, without leaving the object of the invention as claimed.

In this text, the term “comprise(s)” and its derivations (such as “comprising”, etc.) should not be understood in an exclusive sense. That is to say, these terms should not be interpreted as excluding the possibility that what is described and defined may include more elements, stages, etc.

1. A method for converting mechanical energy from oscillations of an oscillating body into electrical energy, the method comprising:
adjusting a displacement of a mass mechanically coupled to an electrical machine, the coupling being such that the electrical machine generates the electrical energy from the displacement of the mass in the oscillations, the displacement being a displacement with respect to the oscillating body,
the mass being mechanically coupled to the body, the mechanical coupling of the mass with the body allowing the displacement of the mass caused by a gravitational force and by a force of the electrical machine applied to the mass in the oscillations,
the oscillations causing variations of an angle of inclination of the oscillating body with respect to a direction of the gravitational force,
the displacement being adjusted by an adjustment of the force applied by the electrical machine to the mass,
the force applied by the electrical machine being adjusted by means-of-a controller on the basis of a measurement of an instantaneous angle of inclination of the oscillating body and on the basis of at least one of: a measurement of an instantaneous position of the mass with respect to the oscillating body or a measurement of an instantaneous velocity of the displacement of the mass,
the controller being configured so that a control objective of the adjustment of the force applied by the electrical machine is to achieve that an instantaneous velocity of the displacement of the mass is positively accelerated by the gravitational force applied to the mass at all instants of the oscillations in which:
a subtraction of the instantaneous angle of inclination of the oscillating body minus the angle of inclination of the body at rest has opposite sign to the sign of the angle of inclination of the body at rest, and an absolute value of the subtraction of the instantaneous angle of inclination of the oscillating body minus the angle of inclination of the body at rest is greater than the absolute value of the angle of inclination of the body at rest; and/or
a subtraction of the instantaneous angle of inclination of the oscillating body minus the angle of inclination of the body at rest has the same sign as the angle of inclination of the body at rest, and
the instantaneous angle of inclination being an angle with respect to a plane perpendicular to the direction of the gravitational force, and the angle of inclination of the body at rest being an angle with respect to the plane perpendicular to the direction of the gravitational force.

2. The conversion method of claim 1, wherein the control objective is that, at all instants of the oscillations, the instantaneous velocity of the displacement of the mass is proportional to the subtraction of the instantaneous angle of inclination of the oscillating body minus the angle of inclination of the body at rest.

3. The conversion method of claim 2, wherein the control objective is based on the instantaneous velocity of the displacement of the mass, the instantaneous angle inclination of the oscillating body, the angle of inclination of the body at rest, an oscillation frequency of the oscillations of the oscillating body, a maximum of an absolute value of the subtraction of the instantaneous angle of inclination of the oscillating body minus the angle of inclination of the body at rest, a predetermined maximum longitude of the displacement of the mass, and a predetermined maximum absolute value of the instantaneous velocity of the displacement of the mass.

4. The conversion method of claim 3, wherein the control objective is:
$${\dot{x}}^{′} = - a \cdot ( ϕ - {ϕ}_{0} )$$
wherein:
\dot{x}′: is the instantaneous velocity of the displacement of the mass (1),
φ: is the instantaneous angle of inclination of the oscillating body,
φ₀: is the angle of inclination of the body at rest, and
a: is an adjustable parameter.

5. The conversion method of claim 4, wherein the adjustable parameter a satisfies that:
$$a \leq \frac{{\vert {\dot{x}}^{′} \vert}_{max}}{A}$$
$$a \leq \frac{{\vert {x}^{′} \vert}_{max} \cdot ω}{A ( 1 + \vert C \vert )}$$
$$a > 0$$
wherein:

|\dot{x}′|ₘₐₓ: is the predetermined maximum absolute value of the instantaneous velocity of the displacement of the mass,

|x′|ₘₐₓ: is the predetermined maximum longitude of the displacement of the mass,
ω: is the oscillation frequency of the oscillations of the oscillating body,
C: is a constant value with respect to time, which depends on the instantaneous position of the mass at t=0, and
A: is an amplitude of the instantaneous angle of inclination of the oscillating body, the instantaneous angle of inclination of the oscillating body satisfying, at least approximately, that:
$$ϕ = A \cdot sin ( ω \cdot t ) + {ϕ}_{0}$$
where t is the time.

6. The conversion method of claim 5, wherein the control objective is defined as:
$${x}^{′} = {a}^{′} \cdot ( \dot{ϕ} - A \cdot ω \cdot C )$$
wherein:
x′: is the instantaneous position of the mass,
\dot{φ}: is a derivative with respect to time of the instantaneous angle of inclination of the oscillating body, and
$${a}^{′} = \frac{a}{{ω}^{2}}$$

7. The conversion method of claim 1, wherein the control objective is based on a maximum electromagnetic torque applicable by the electrical machine or wherein a maximum electromagnetic torque applicable by the electrical machine is based on the control objective.

8. The conversion method of claim 1, wherein the body is floating in water and the oscillations of the body are caused by water waves.

9. The conversion method of claim 8, wherein the method comprises measuring a height of a wave before the wave reaches the body, and wherein the controller is configured to adjust the force applied, by the electrical machine, on the basis of the measurement of the wave height.

10. A system for converting mechanical energy from oscillations into electrical energy, the system comprising an oscillating body, an electrical machine, a mass, a controller, a mechanical coupling of the mass with the body, and a mechanical coupling of the mass with the electrical machine,
wherein the mechanical coupling of the mass with the electrical machine is configured so that the electrical machine generates electrical energy from displacement of the mass with respect to the body, the mechanical coupling of the mass with the body is configured to allow a displacement of the mass with respect to the body caused by a gravitational force and by a force of the electrical machine applied to the mass in the oscillations,
wherein the system is configured to adjust the displacement of the mass by an adjustment of a force applied by the electrical machine to the mass,
wherein the controller is configured to adjust the force applied by the electrical machine on the basis of a measurement of an instantaneous angle of inclination of the oscillating body and on the basis of at least one of: a measurement of an instantaneous position of the mass with respect to the oscillating body and a measurement of an instantaneous velocity of the mass with respect to the oscillating body, and
wherein the controller is configured so that a control objective of the adjustment of the force applied by the electrical machine is to achieve that an instantaneous velocity of the displacement of the mass is positively accelerated by the gravitational force applied to the mass at all instants of the oscillations in which:
a subtraction of the instantaneous angle of inclination of the oscillating body minus the angle of inclination of the body at rest has opposite sign to the sign of the angle of inclination of the body at rest, and an absolute value of the subtraction of the instantaneous angle of inclination of the oscillating body minus the angle of inclination of the body at rest is greater than the absolute value of the angle of inclination of the body at rest; and/or
a subtraction of the instantaneous angle of inclination of the oscillating body minus the angle of inclination of the body at rest has the same sign as the angle of inclination of the body at rest,
wherein the instantaneous angle of inclination is an angle with respect to a plane perpendicular to a direction of the gravitational force, and the angle of inclination of the body at rest is an angle with respect to the plane perpendicular to the direction of the gravitational force.

11. The system of claim 10, wherein the mechanical coupling of the oscillating body with the mass comprises:
a mechanical coupling of the mass with straight guides and a gear of a rack with a sprocket;
a center of the sprocket being mechanically connected to a rotary shaft perpendicular to the sprocket, the rotary shaft being mechanically connected to a rotor of the electrical machine; and
a stator of the electrical machine being integral with the mass.

12. The system of claim 11, wherein the rotary shaft is mechanically connected to a multiplier mechanism and/or to an inertia flywheel, the multiplier mechanism and/or the inertia flywheel being sandwiched between the sprocket and the rotor.

13. A system comprising an oscillating body, an electrical machine, a mass, mechanical couplings, and a controller configured to perform the method of claim 1.
